(19) United States
(12) Patent Application Publication
(10) Pub. No.: US 2026/0174266 A1
(43) Pub. Date: Jun. 25, 2026

(54) WINDOW SHADE SYSTEM AND OPERATIONAL METHOD THEREOF

(71) Applicant: Michael Lin, Buffalo, NY (US)

(72) Inventor: Michael Lin, Buffalo, NY (US)

(21) Appl. No.: 18/987,058

(22) Filed: Dec. 19, 2024

(51) Int. Cl. A47H 1/13; E06B 9/42

(52) U.S. Cl. CPC A47H 1/13; E06B 9/42

(57) ABSTRACT

The present disclosure relates to a window shade system for maintaining a retractable shade within a window frame. The system comprising a window shade mounted at an upper end of the window frame. The system comprising a first side channel positioned adjacent the first side of the shade, mounted to the window frame. The system comprising a pair of inward flanges that project inwardly toward each other to define a slit therebetween on the first open side that extends in a longitudinal direction. The system comprising a second side channel positioned adjacent the second side of the shade, mounted to the window frame. The system comprising a pair of inward flanges that project inwardly toward each other to define a slit therebetween on the second open side. The system comprising a plurality of bead structures attached along an edge of the first side and the second side of the shade.

### FIELD OF THE DISCLOSURE

Embodiments of the present disclosure relate to the field of interior window treatments and coverings, and specifically relates to a window shade apparatus and system that facilitate maintaining shade position within side channels while allowing smooth and controlled movement of the window shade.

### DESCRIPTION OF THE RELATED ART

Window shades are a fundamental component of interior design, serving not only to enhance privacy and regulate light but also to contribute significantly to the room's overall aesthetics. The efficient operation of window shades largely relies on a smooth sliding mechanism that allows for easy opening, closing, and adjusting of the window shade fabric. This mechanism is vital for maintaining the alignment and stability of the window shades; any malfunction can result in operational difficulties such as uneven movement, fabric misalignment, and such.

The sliding mechanism is designed to ensure smooth and controlled movement of the window shades, typically utilizing a series of tracks or rails that guide the window shade along a vertical or horizontal path. Maintaining proper alignment and ensuring effortless operation of the blinds is heavily dependent on the condition of the sliding mechanism. Poor maintenance or component misalignment can create resistance, causing the window shades to move unevenly or become stuck, leading to user frustration and potential long-term damage to the window shades.

A common problem with window shades, especially those incorporating fabric materials, is the lack of smooth gliding and the frequent misalignment. Such issues arise when the fabric moves unevenly or gets caught during operation, resulting in jerky or erratic movements. Over time, these alignment issues can cause the fabric to bunch up or shift to one side, degrading the visual appeal of the window shades and compromising functionality. Persistent misalignment can accelerate wear and tear on both the fabric and the sliding mechanism, thereby reducing the overall lifespan of the window shades.

Given these limitations, there is a need for an improved solution that effectively secures the fabric of the window shades within side channels, and minimizes friction. There is a need for a solution that can even work with the existing window shades, providing a smoother gliding mechanism, and ensuring a long lifespan for both the window shade fabric.

Therefore, the present disclosure provides a window shade system that can overcome above mentioned limitations.

### SUMMARY OF THE DISCLOSURE

The present disclosure provides for a window shade system and its installation method, utilizing bead attachments to secure the shade within side channels. The system includes a window frame with a window shade mounted at its upper end. The window frame system also features at least two side channels, one on each vertical side, mounted in the interior or on the face of the frame, allowing the window shade to slide and remain positioned in the channels when being rolled up or down. The system also incorporates multiple bead structures attached along the edge of the window shade. Each side channel has a narrow slit for inserting the window shade with bead attachments along its edge. These bead structures are designed to retain the edges of the window shade within the narrow slit of the side channels while permitting the shade to slide along the length of the channels. Each of the two side channels can be mounted either inside the window frame or on its face using a connecting/mounting means such as screws, nails or staples and the like. Additionally, the side channel mounted on the face of the window frame has a cover that can be removably attached over the connecting means.

A general object of the present disclosure is to provide a window in shade system wherein two side channels can be connected to either the interior or the face of the window frame.

Yet another object of the present disclosure, is to provide a window shade system wherein the side channel mounted on the face of the window frame further comprises a cover removably attachable to each of the two side channels to aesthetically cover the connecting means.

Another object of the present disclosure is to provide a v-notch to aid in the alignment and insertion of the connecting means such as a screw for mounting the two side channels to the window frame.

A further object of the present disclosure, is to provide a narrow slit in communication with a plurality of bead structures that together retains the window shade within the two side channels.

Another object of the present disclosure is to provide two side channels that are customizable in shape and size.

In still a further object the present disclosure is to provide a window shade system having bead structures that can be attached and removed at any spacing distance along the window shade.

Another object of the present disclosure is to provide a plurality of bead structures composed of a flexible or semi-rigid material to facilitate attachment to the side of the window shade to accommodate insertion and removal from the two side channels.

Another objective of the present disclosure is to provide bead structures consisting of a male part and a female part, which can be easily installed on existing shades.

Another objective of the present disclosure is to provide a series of bead structures that can be attached to the window shade using an extension strip, allowing for adjustments to fit different window frame sizes.

Another objective of the present disclosure is to provide an operational method for a window shade by attaching multiple bead structures along both vertical edges of the window shade.

Embodiments of the present invention relate to a window shade system for maintaining a retractable shade within a window frame. The system comprising a window shade mounted at an upper end of the window frame. The shade extending a width between a first side and a second side. The shade extending a length between an upper end and a lower end, wherein the shade is deployed and retracted between an open position and a closed position. The system also comprising a first side channel positioned adjacent the first side of the shade, mounted to the window frame and the first side channel having an end wall and a pair of opposing sidewalls forming a first open chamber. The system also comprising a pair of inward flanges that project inwardly toward each other to define a slit therebetween on the first open side that extends in a longitudinal direction and opens laterally allowing insertion of the first side of the window shade within the first side channel. The system also comprising a second side channel positioned adjacent the second side of the shade, mounted to the window frame and the second side channel having an end wall and a pair of opposing sidewalls forming a second open chamber. The system also comprising a pair of inward flanges that project inwardly toward each other to define a slit therebetween on the second open side that extends in a longitudinal direction and opens laterally allowing insertion of the second side of the window shade within the second side channel. The system also comprising a plurality of bead structures attached along an edge of the first side and the second side of the shade and each of the plurality of the bead structures is sized at a thickness that is greater than the width of the slit so as to be retained within the first and second side channels while permitting sliding movement of the window shade along the length of each of the two side channels.

In an embodiment of the present disclosure, each of the plurality of bead structures is a removable bead structure comprised of a male part having a post and a female part is a hollow ring-like structure that has a plurality of internal flaps to secure placement with respect to the post of the male part.

In an embodiment of the present disclosure, each of the bead structures is composed of a flexible or semi-rigid material to facilitate insertion and removal from the two side channels.

In an embodiment of the present disclosure, each of the bead structures are attached to an extension strip that is used to adjust the width of the window shade to fit the window frame.

In an embodiment of the present disclosure, each of side channels are a side channel assembly, each mounted to a face of the widow frame, each having a cover removably attachable to the first and second side channel.

In an embodiment of the present disclosure, each of the first and second side channels are mounted to an interior surface of the widow frame.

Another embodiment of the present invention relates to an operational method for window shade. The operational method comprises mounting a first and second side channel, each having an open side with a slit, to a window frame using a connecting means. The operational method also comprises attaching a plurality of bead structures to an edge of a first side and a second side of the window shade, wherein each of the plurality of the bead structures is sized at a thickness that is greater than the width of the slit so as to be retained within the first and second side channels while permitting sliding movement of the window shade along the length of each of the two side channels. The operational method also comprises inserting the window shade with the plurality of bead structure into each of the two side channels. The two side channels retain the edges of the first side and the second side of the window shade when the shade is deployed and retracted between an open position and a closed position.

In an embodiment of the present disclosure, the assembly of each of the plurality of bead structure is attached an extension strip to the window shade.

In an embodiment of the present disclosure, the plurality of bead structures is equidistantly attached along the edges of the first side and the second side of the window shade to provide a uniform spacing when the shade is retracted to the closed position.

In an embodiment of the present disclosure, the two side channels include a pair of inward flanges to prevent displacement of the window shade with the plurality of bead structure inserted within the two side channels.

Other systems, devices, apparatuses, methods, features, and advantages will be become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

So that the manner in which the above-recited features of the present disclosure is understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

The disclosure herein will be better understood from the following description with reference to the drawings, in which:

FIG. 1 is a perspective view of a window shade system fitted into a window frame, according to an embodiment of the present disclosure;

FIG. 2 illustrates a front view of the window shade system mounted to the interior of a window frame, according to an embodiment of the present disclosure;

FIG. 3 illustrates a front view of the window shade system mounted to the front of a window frame, according to an embodiment of the present disclosure;

FIG. 4 illustrates a sectional perspective view of an interior side channel to be mounted to the interior of the window frame, according to an embodiment of the present disclosure;

FIG. 5 illustrates a sectional perspective view of a front side channel to be mounted to the front of a window frame with a cover attached;

FIG. 6 illustrates a sectional exploded view of a front side channel to be mounted to the face of a window frame with a cover detached;

FIG. 7 is a cross-section view, taken generally along line 7-7 in FIG. 3, according to an embodiment of the present disclosure;

FIG. 8 is a cross-section view, taken generally along line 8-8 in FIG. 2, according to an embodiment of the present disclosure;

FIG. 9 illustrates a side view of a window shade wound around a roll-up shaft, according to an embodiment of the present disclosure;

FIG. 10A illustrates a detailed view of a male part of the bead structure, according to an embodiment of the present disclosure;

FIG. 10B illustrates a detailed view of the female part of the bead structure, according to an embodiment of the present disclosure;

FIG. 10C illustrates a detailed view of the bead structure, according to an embodiment of the present disclosure;

FIG. 11 illustrates a detailed view of a bead structure attached to the window shade, according to an embodiment of the present disclosure;

FIG. 12 illustrate a detailed view of a bead structure fastened on the extension strip attached to the window shade, according to an embodiment of the present disclosure;

FIG. 13 illustrates diagram of a window shade system, according to an embodiment of the present disclosure; and

FIG. 14 illustrates a flowchart for an operational method for a window shade, according to an embodiment of the present disclosure.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE DISCLOSURE

In the following detailed description, numerous specific details are set forth in order to provide a thorough understanding of the embodiment of the disclosure as illustrative or exemplary embodiments of the disclosure, specific embodiments in which the disclosure may be practiced are described in sufficient detail to enable those skilled in the art to practice the disclosed embodiments. However, it will be obvious to a person skilled in the art that the embodiments of the disclosure may be practiced with or without these specific details. In other instances, well-known methods, procedures and components have not been described in detail so as not to unnecessarily obscure aspects of the embodiments of the disclosure.

The following detailed description is, therefore, not to be taken in a limiting sense, and the scope of the present disclosure is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Disclosure

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

Conventionally, roll-up type window screens include side channels laterally adjacent to the window frame, a shade, and a roll-up shaft that functions as a spool for winding the screen to and from an open and closed position. The roll-up shaft is designed to manage, store, and dispense the shade material. It allows the screen or shade to be neatly stored when not in use and easily deployed when needed.

The side channels are used to block light that enters the room at the sides of the window shade and also are used to guide the window shade. In room darkening applications, no light penetrates through the shade cloth, but outside light enters the room through the gaps at the sides of the shade. Although current side channels used in interior applications block light effectively, the fabric shade can easily be pushed out of the channels, disrupting its operation. Operating the shade with the fabric partially inside or outside the channel can result in damage to the fabric.

Some window shades currently used with side channels have been developed for large outdoor screens by incorporating a zipper or thicker edge along the window shade, which fits into a narrow slit in the side channels. The expanded edge or zipper prevents the fabric from exiting the side channels. The thickness of the expanded edge within the side channel is greater than the width of the slit. However, the expanded edge creates more friction and occupies more space when rolled up on the roll-up shaft. Due to the increased volume from the expanded edge, the roll-up shaft must be tapered or stepped to accommodate the additional roll diameter of the zipper/expanded edge. Also, a screen with an expanded edge extending the entire length of the screen requires a large heavy bottom bar to provide enough weight to pull the expanded edge through the side channel. As a result, a window shade with an expanded edge cannot be implemented for smaller interior window shades.

The present disclosure describes a window shade system and an installation method that includes a series of small beads or attachments along the edge of the window shade. These beads help maintain the shade's position within a narrow slit on each side channel. By using a minimal number of beads, the shade's movement is not hindered by excess weight and volume along its edge. Using beads instead of a thicker edge reduces the volume of the shade. Consequently, when the shade is rolled onto the roll-up shaft, there is no need to modify the shaft because the additional volume of the beads is negligible. In addition, this system can be operated without requiring extra weight at the bottom of the shade.

The present disclosure describes a window shade system for maintaining a retractable shade within a window frame having a window shade mounted at an upper end of the window frame. The shade extending a width between a first side and a second side and a length between an upper end and a lower end, wherein the shade is deployed and retracted between an open position and a closed position. A first side channel is mounted to the window frame positioned adjacent the first side of the shade. The first side channel having an end wall and a pair of opposing sidewalls forming an open chamber 109. A pair of inward flanges 107 that project inwardly toward each other from the ends of the opposing sidewalls define a slit therebetween that extends in a longitudinal direction and opens laterally allowing insertion of the first side of the window shade within the first side channel.

A second side channel is positioned adjacent the second side of the shade, mounted to the window frame, the second side channel having an end wall and a pair of opposing sidewalls forming an open chamber 109. A pair of inward flanges 107 that project inwardly toward each other from the ends of the opposing sidewalls define a slit therebetween that extends in a longitudinal direction and opens laterally allowing insertion of the first side of the window shade within the second side channel.

A plurality of bead structures attached along an edge of the first side and the second side of the shade, wherein each of the plurality of the bead structures is sized at a thickness that is greater than the width of the slit so as to be retained within the first and second side channels while permitting sliding movement of the window shade along the length of each of the two side channels.

Additionally, this disclosure includes a method for retrofitting this apparatus to existing shades installed in window frames.

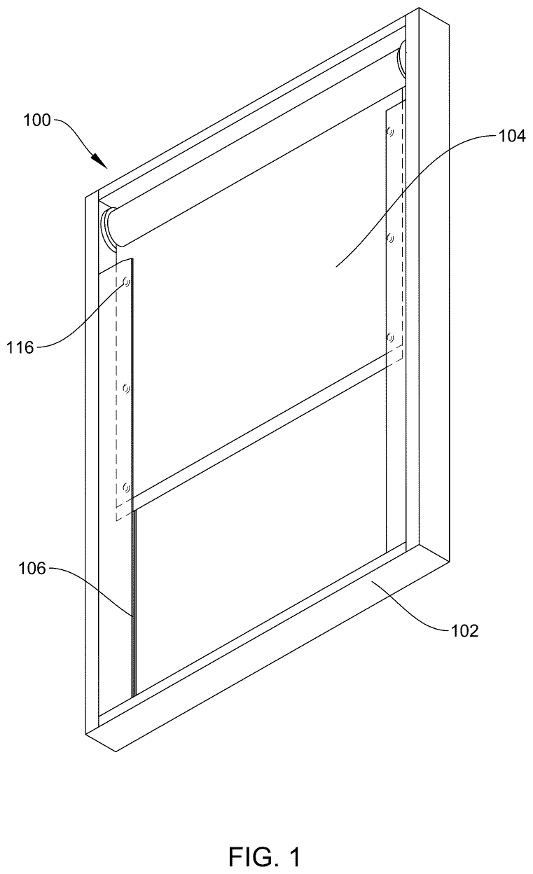

Averting now to the drawings, with reference to FIG. 1, a preferred embodiment of the present disclosure is depicted. FIG. 1 is a perspective view of a window shade system fitted into a window frame, according to an embodiment of the present disclosure. The present disclosure provides for a window shade system 100 comprising a window frame 102 having a window shade 104 mounted at an upper end of the window frame 102. The window frame 102 in this embodiment has at least two interior side channels 106, one on each side, laterally mounted to the interior of the window frame 102 and configured to allow sliding movement of the window shade 104. Each interior side channel 106 further comprises a narrow slit 114 (shown in FIG. 6) for securing the window shade 104 within the interior side channel 106. The window shade includes a plurality of bead structures 116 attached along an edge of the window shade 104 (illustrated in FIGS. 1-3 with broken lines on the side channels to show the position bead structures 116 on window shade 104). The plurality of bead structures 116 are positioned within each side channel and held in place by a slit 114 while permitting sliding movement of the window shade 104 along the length of the two interior side channels 106. The thickness of bead structures 116 within the side channel is greater than the width of the slit 114.

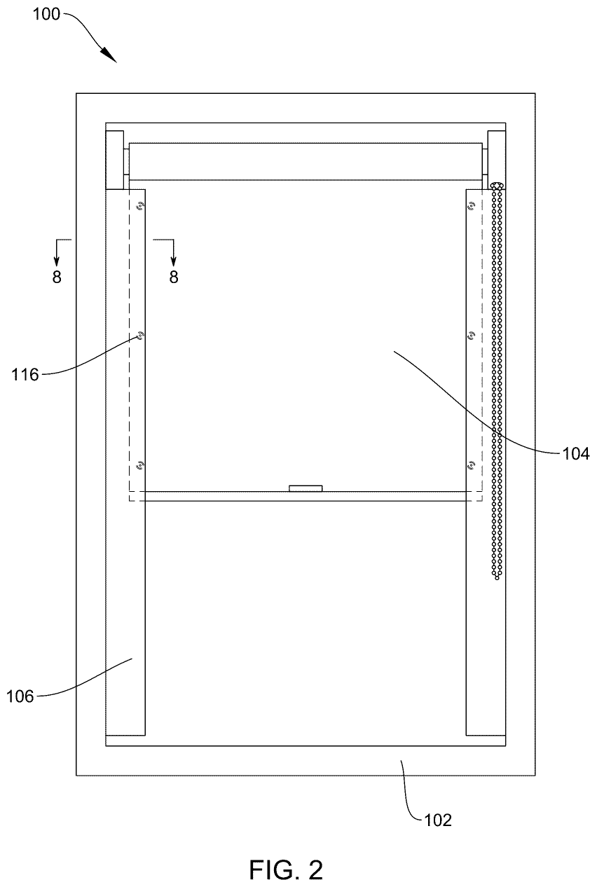

FIG. 2 illustrates a front view of the window shade system mounted to the interior of a window frame, according to an embodiment of the present disclosure. In this embodiment the channels are mounted to the interior of the widow frame and there is no need to provide a cover to hide the connecting means, such as screws or nails.

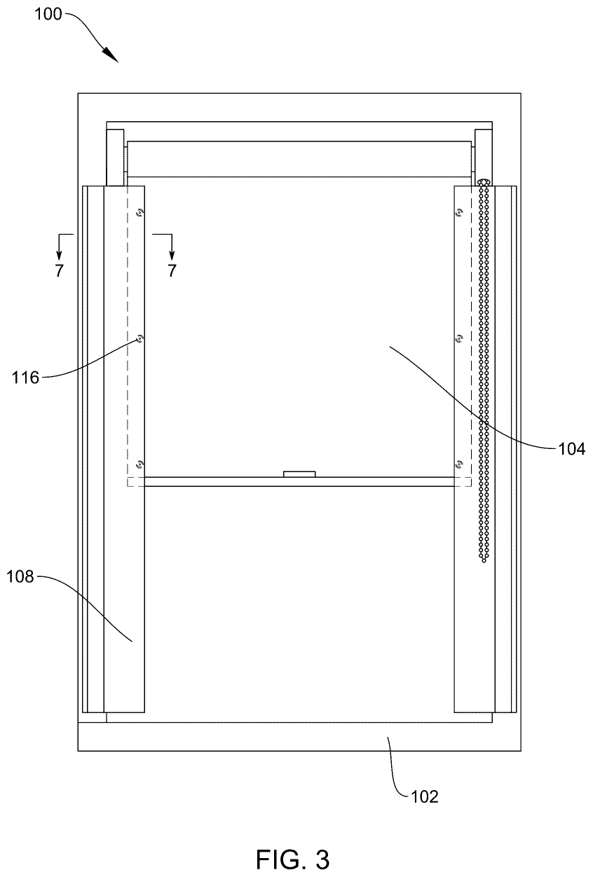

FIG. 3 illustrates a front view of the window shade system mounted to the front of a window frame, according to an embodiment of the present disclosure. Each of the two front side channels 108 further comprise a cover 112 that is removably attachable to each of the two front side channels 108. The front side channels 108 provide a secure guide along which the window shade 104 can slide. The plurality of bead structure 116 are attached along the edge of the window shade further ensures that the window shade 104 stays securely within the front side channels 108, preventing any misalignment.

The use of modular design for the cover 112 simplifies maintenance and cleaning. The secure fit of the window shade 104 within the front side channels 108 ensures a neat appearance with no fabric bulging or sagging, maintaining an elegant look for both residential and commercial settings.

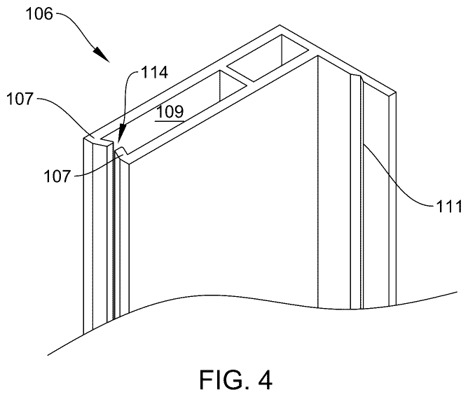

FIG. 4 illustrates a sectional perspective view of an interior side channel 106 to be mounted to the interior of the window frame, according to an embodiment of the present disclosure. Each side channel is positioned and mounted to the window frame adjacent to each side of the shade. Each side channel having an end wall and a pair of opposing sidewalls forming an open chamber 109. The opposing sidewalls have a connecting end attached to the end wall and an open end distal to the end wall. A pair of inward flanges 107 that project inwardly toward each other from the open ends of the opposing sidewalls define a slit therebetween that extends in a longitudinal direction and opens laterally allowing insertion of the first side of the window shade within the second side channel.

Each of the two side channels (interior side channel 106 and front side channel 108) can be mounted either inside the window frame or on its face using a connecting means such as screws 110, however any known connecting means such as nails, glue or staples and the like can be used. The connecting means in this embodiment is used in conjunction with v-notch 111 which is a grove that extends the length of the side channel of the to receive a screw 110 anywhere along the grove for mounting the side channels to the window frame 102. In an embodiment of the present disclosure, any other type of connecting means may be used to securely mount the interior and front side channels to the window frame 102.

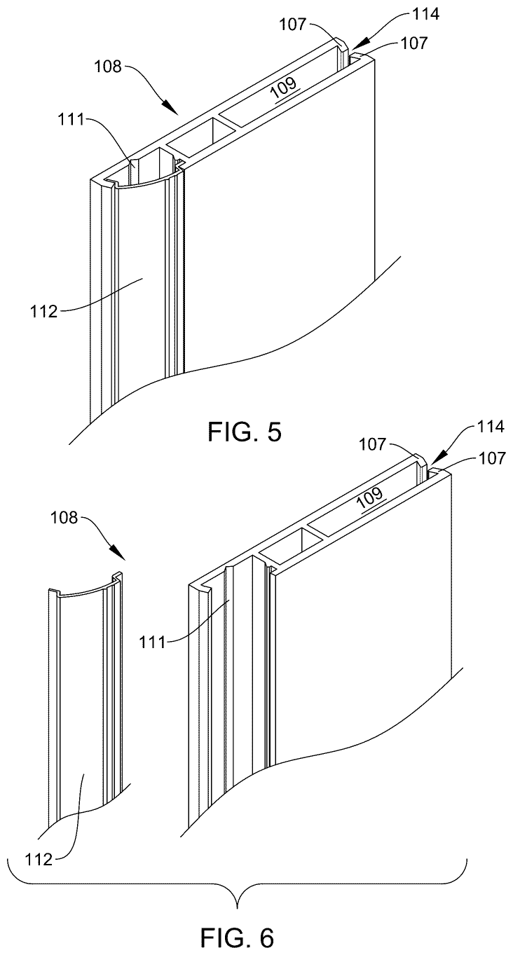

FIG. 5 illustrates a sectional perspective view of a front side channel to be mounted to the front of a window frame with a cover attached. FIG. 5 illustrates a view of front side channels 108 to be mounted to the face of the window frame 102 with the cover 112, according to an embodiment of the present disclosure.

FIG. 6 illustrates a sectional exploded perspective view of a front side channel 108 to be mounted to the face of a window frame with a cover detached. The use of modular design for the cover 112 simplifies maintenance and cleaning. The secure fit of the window shade 104 within the side channels 106 ensure a neat appearance with no fabric bulging or sagging, maintaining an elegant look for both residential and commercial settings.

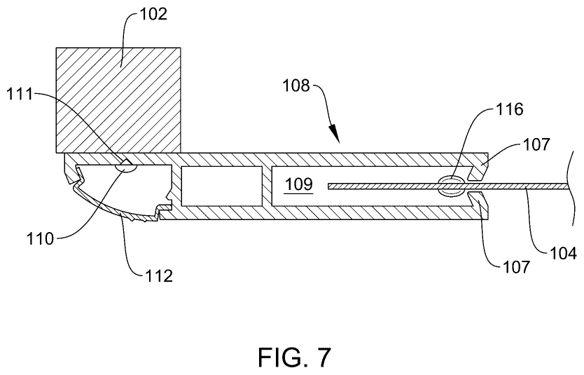

FIG. 7 is a cross-section view of a front side channel 108 attached to window frame 102, taken generally along line 7-7 in FIG. 3, according to an embodiment of the present disclosure. The removable cover 112 protects the internal components of the two front side channels 108 from dust and debris and hides the screws 110 once installed. The inclusion of plurality of bead structure 116 to the window shade 104 allows smooth movement within the side channels. It prevents jerky or uneven movement by keeping the window shade 104 aligned and secured within the interior side channel 106 and front side channel 108 via the narrow slit 114 during operation, reducing wear and tear on the fabric and extending the lifespan of the window shade 104.

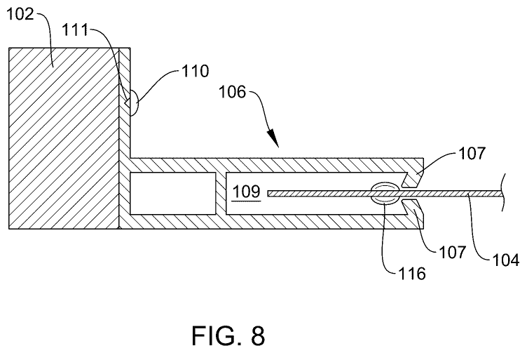

FIG. 8 is a cross-section view, taken generally along line 8-8 in FIG. 2, according to an embodiment of the present disclosure. FIG. 8 illustrates a cross-section view of the interior side channel 106 mounted to the interior of window frame 102, according to an embodiment of the present disclosure. In an embodiment of the present disclosure, the interior side channels 106 dimensions vary as per the width and length of the window frame.

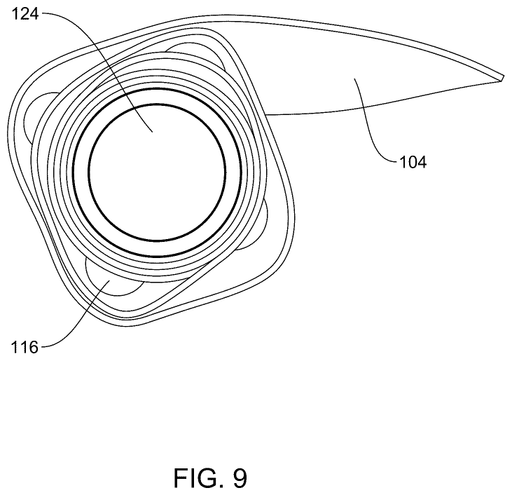

FIG. 9 illustrates a side view of a window shade wound around a roll-up shaft 124, according to an embodiment of the present disclosure. Roll-up shaft 124 acts as a spool, a cylindrical device used to wind and store window shade 104. In this embodiment there are four bead structures 116. The plurality of bead structures 116 are attached at predetermined equal distances on the window shade 104, resulting in minimal added volume and symmetrical four-corner positions when rolled up on the roll-up shaft. The number of bead structures 116 placed on the shade is dependent on the length of the shade. The plurality of bead structure 116 may be composed of a flexible or semi-rigid material to maintain position within the side channels. Unlike traditional systems that rely on zippers or other bulky mechanisms, the disclosed disclosure significantly reduces friction during operation and bulky roll when deployed to the open position.

The inclusion of plurality of bead structure 116 to the window shade 104 allows smooth movement within the side channels. It prevents jerky or uneven movement by keeping the window shade 104 aligned and secured within the interior side channel 106 and front side channel 108 via the narrow slit 114 during operation, reducing wear and tear on the fabric and extending the lifespan of the window shade 104.

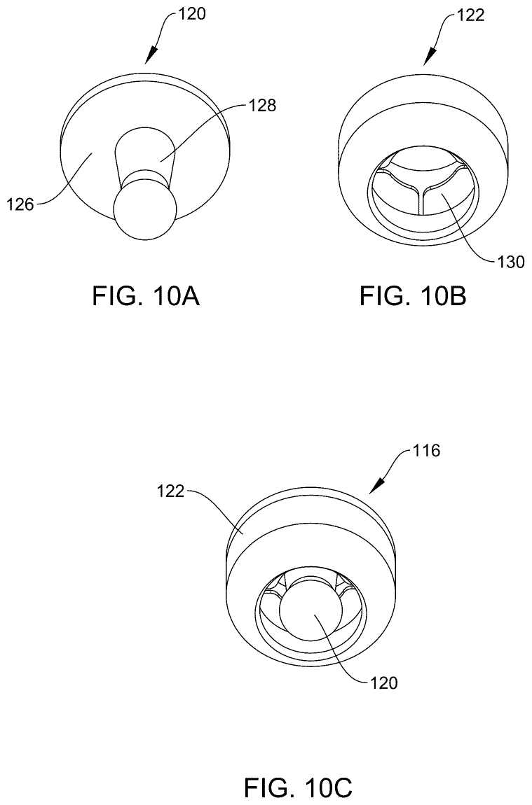

FIGS. 10A-10C illustrate a detailed view of the male part 120 and the female part 122 forming the bead structure 116, according to an embodiment of the present disclosure. FIG. 10A illustrates a detailed view of a male part of the bead structure, according to an embodiment of the present disclosure. The male part 120 and female part 122 of the plurality of bead structure 116, are designed to interlock securely, which provides added stability to the bead structure 116. FIG. 10B illustrates a detailed view of the female part of the bead structure, according to an embodiment of the present disclosure. In an embodiment of the present disclosure, the female part has a plurality of internal flaps to secure placement with respect to the notch of the male part.

This configuration minimizes the risk of misalignment and fabric skewing, common issues in traditional window shade, ensuring a consistent and aesthetically pleasing appearance. The plurality of bead structure 116 may comprise a male part 120, and a female part 122 placed over the male part 120. The male part 120 may include a flat bottom surface 126, and a post 128 jutting out of the flat bottom surface 126. The female part 122 may be a hollow ring-like structure. The female part 122 may have a plurality of internal flaps 130 to secure placement with respect to the post 128 of the male part 120. In an embodiment of the present disclosure, the bead structure 116 may be of any other shape, size, and configuration. The male part includes a flat bottom surface, and a post jutting out of the flat bottom surface. In an embodiment of the present disclosure, the female part is a hollow ring-like structure.

FIG. 10C illustrates a detailed view of the bead structure, according to an embodiment of the present disclosure. In an embodiment of the present disclosure, the male part 120 having a flat bottom surface 126 that provides a stable base that prevents any bulging or distortion of the window shade 104 within the side channels 106. In some embodiments, the post 128 that juts out from the flat bottom surface 126 may be shaped in various forms, such as a rectangular or trapezoidal protrusion, to facilitate secure interlocking with the female part 122. The post 128 may be designed to align perfectly with the corresponding female part 122, allowing for quick and easy assembly or disassembly. Unlike traditional systems that rely on zippers or other bulky mechanisms, the disclosed disclosure using spaced apart bead structures significantly reduces friction during operation.

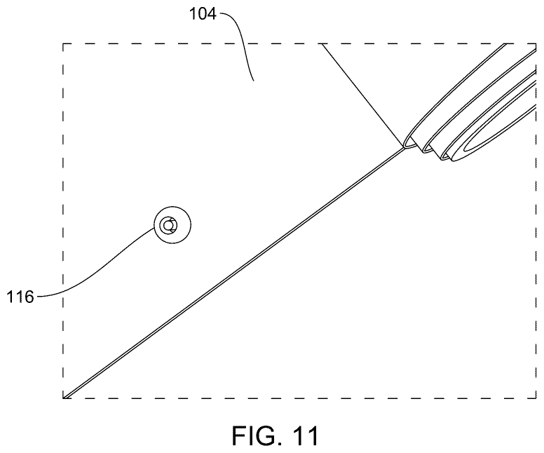

FIG. 11 illustrates a detailed view of a bead structure 116 attached to the window shade 104, according to an embodiment of the present disclosure.

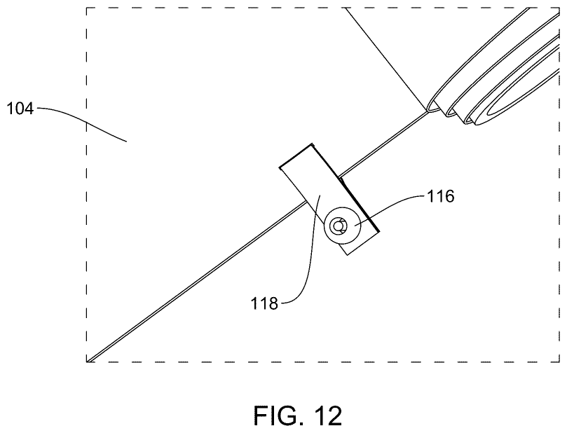

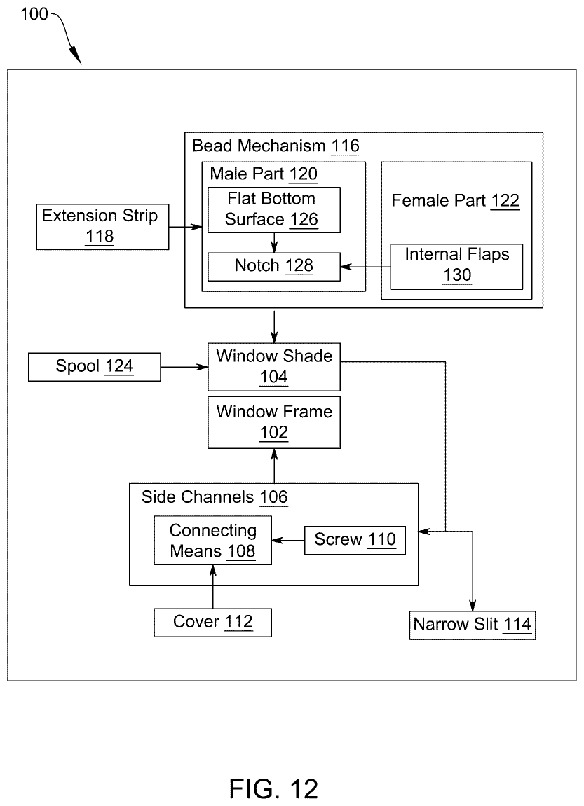

FIG. 12 illustrates a detailed view of the plurality of bead structure 116 fastened to the edges of the window shade 104 with an extension strip 118, according to an embodiment of the present disclosure. The window shade 104 may have at least one an extension strip 118 attached along the edges. At least one bead structure 116 may be attached on the extension strip 118. The extension strip 118 is used to adjust the width of the window shade 104 to fit various window sizes.

The system 100 may include a spool mechanism mounted at an upper end of the window frame 102 for rolling and unrolling the window shade 104 attached with the plurality of bead structure 116. In order to avoid redundancy, components analogous to the system 100 described above are not reiterated.

The system 100 may comprise a window frame 102, a window shade 104, at least two side channels 106, and a plurality of bead structure 116.

The two side channels 106, one on each side, may be mounted exterior to the window frame 102 and the two side channels 106 configured to allow sliding movement of the window shade 104.

Each of the two side channels 106 may further comprise a connecting means 108. Each of the two side channels 106 may further comprise a cover 112 removably attachable to the two side channels 106 over the connecting means 108. Each of the two side channels 106 may further comprise a narrow slit 114 allowing insertion of the window shade 104 within the two side channels 106.

In order to avoid redundancy, components analogous to the system 100 described above are not reiterated.

The system 100 may comprise a window frame 102, a window shade 104, at least two side channels 106, and a plurality of bead structure 116. The two side channels 106, one on each side, may be mounted interior to the window frame 102 and the two side channels 106 configured to allow sliding movement of the window shade 104.

Each of the two side channels 106 may further comprise a connecting means 108 configured to receive a screw 110 for mounting the two side channels 106 to the window frame 102. Each of the two side channels 106 may further comprise a narrow slit 114 allowing insertion of the window shade 104 within the two side channels 106.

In a preferred embodiment, the window shade is keep straight using a roller tube.

In an embodiment of the present disclosure, the window frame 102 serves as the primary structure for supporting the window shade system 100. The window frame 102 may be constructed from various materials, such as wood, aluminum, or PVC, in different architectural styles and various dimensions. In a preferred embodiment, the window shade 104 may be a blind fabric composed of materials such as, but not limited to, lightweight polyester or nylon sheer, multi-layered polyester with a blackout coating, or solar screen fabrics.

In a preferred embodiment, the side channels 106 may be made from materials such as, but not limited to, anodized aluminum, high-density polyethylene (HDPE), polyvinyl chloride (PVC), steel or aluminum channels with embedded magnets, or a combination of metals and durable plastics incorporating a spring mechanism.

In an embodiment of the present disclosure, the screw 110 may securely hold the side channels 106 to the window frame 102 via the v-notch, ensuring a seamless and integrated appearance. The modular design of the side channel with the v-notch and the cover 112 enables easy installation or replacement, reducing maintenance efforts and costs.

In an embodiment of the present disclosure, the side channels 106 may be mounted along the sides of the window frame 102 and act as a guide to the window shade 104, maintaining its alignment and preventing it from swaying or leaving the designated path. In an embodiment of the present disclosure, the width of the narrow slit is designed to be compatible with the diameter of the bead structure 116, in a manner to allow insertion of the window shade 104 with the plurality of bead structure 116 and to retain the bead structures 116 within the side channels 106.

In an embodiment of the present disclosure, the male part 120 and the female part 122 forming the bead structure 116 may be constructed from materials such as, but not limited to, flexible silicone, semi-rigid polyvinyl chloride (PVC), or reinforced nylon. The extension strip 118 may be composed of flexible silicone, semi-rigid polyvinyl chloride (PVC), reinforced nylon, or any other suitable material. The extension strip 118 provides flexibility in installation and enhances the versatility of the window shade system, making it suitable for a wide range of window dimensions. Additionally, the extension strip 118 allows for quick adjustments, minimizing installation time and reducing costs associated with purchasing multiple window shade sizes.

The use of flexible or semi-rigid materials in the extension strip 118, the male part 120, and the female part 122 may allow slight deformation of the plurality of bead structure 116 to facilitate easy insertion and removal while maintaining a secure hold within the side channels 106. The plurality of bead structure 116 may minimize friction and wear, ensure consistent alignment, and prevent the window shade 104 from escaping the side channels 106, contributing to a longer lifespan and improved functionality of the window shade system 100.

In a preferred embodiment, the male part 120 and the female part 122 may have a complementary locking mechanism within the plurality of bead structure 116. The interlocking design allows the plurality of bead structure 116 to maintain its position within the side channels 106, preventing the window shade 104 from detaching during operation. The interlocking mechanism provides added stability and ensures smooth gliding while minimizing the risk of misalignment or fabric bunching. Additionally, the male part 120 and the female part 122 may be easily connected or disconnected, facilitating maintenance and replacement, as required.

In some embodiments, the female part 122 having the ring-like shape may be in circular, oval, or another geometric shape that complements the design of the male part 120. In an embodiment of the present disclosure, the internal flaps 130 are strategically positioned within the hollow ring-like structure to flex inward or outward to accommodate the post 128 of the male part 120 when inserted.

FIG. 13 illustrates a diagram of window shade system 100 using bead attachment, according to an embodiment of the present disclosure. The system 100 comprising a window frame 102, a window shade 104, at least two side channels 106, and a plurality of bead structure 116. The window frame 102 having a window shade 104 mounted at an upper end of the window frame 102. The two side channels 106, one on each side, may be mounted within or adjacent to the window frame 102 and the side channels 106 configured to allow sliding movement of the window shade 104. The side channel 106 further comprises the narrow slit 114 allowing insertion of the window shade 104 within the side channel 106.

The plurality of bead structure 116 may be attached along an edge of the window shade 104 and the plurality of bead structure 116 configured to retained edges of the window shade 104 within the narrow slit 114 while permitting sliding movement of the window shade 104 along the length of the two side channels 106. The plurality of bead structure 116 may be sized to be retained within the narrow slit 114 while permitting sliding movement of the window shade 104 along the length of the two side channels 106.

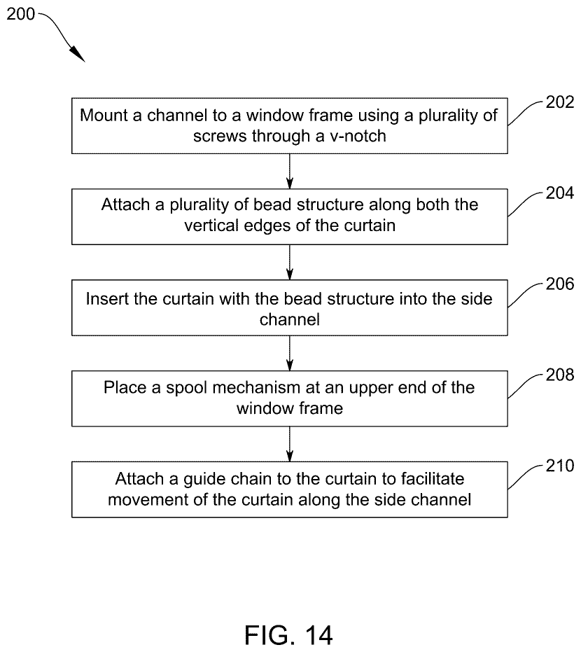

FIG. 14 illustrates a flowchart for an operational method 200 for window shade, according to an embodiment of the present disclosure. The operational method 200 may comprise the following steps:
At 202, mounting a channel to a window frame 102 using a plurality of screws 110 through a connecting means 108.

At 204, attaching a plurality of bead structure 116 along both the vertical edges of a window shade 104.

At 206, inserting the window shade 104 with the plurality of bead structure 116 into the two side channel 106. The two side channel 106 may retain the window shade 104 while allowing sliding movement.

At 208, placing a spool mechanism at an upper end of the window frame 102.

At 210, attaching a guide chain to the window shade 104 to facilitate movement of the window shade 104 along the two side channel 106.

The assembly of each of the plurality of bead structure 116 may include securing a male part 120 on an extension strip 118.

The assembly of the bead structure 116 may also include inserting the female part 122 over the male part 120.The insertion of the female part 122 may be onto the corresponding male part 120 along the edge of the window shade 104 secures fastening of the bead structure 116. The plurality of bead structure 116 may be equidistantly attached along the vertical edge of the window shade 104 to provide a uniform appearance and ensure smooth operation. The two side channels 106 include a pair of inward flanges 107 to prevent displacement of the window shade 104 with the plurality of bead structure 116 inserted within the two side channels 106.

In some embodiments, the side channel 106 may be mounted to the window frame 102 by inserting a plurality of screws 110 through a v-notch located on the side channel. The v-notch may be designed to precisely align the channel and securely hold it against the window frame 102. The screws 110 may be made from corrosion-resistant materials such as stainless steel or coated metal to provide durability and withstand environmental factors.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A window shade system for maintaining a retractable shade within a window frame, the system comprising:
a window shade mounted at an upper end of the window frame;
the shade extending a width between a first side and a second side;
the shade extending a length between an upper end and a lower end, wherein the shade is deployed and retracted between an open position and a closed position;
a first side channel positioned adjacent the first side of the shade, mounted to the window frame, the first side channel having a first end wall and a pair of first opposing sidewalls forming a first open chamber;
a pair of first inward flanges on the pair of first opposing sidewalls that project inwardly toward each other to define a first slit therebetween that extends in a longitudinal direction and opens laterally allowing insertion of the window shade within the first side channel;
a second side channel positioned adjacent the second side of the shade, mounted to the window frame, the second side channel having a second end wall and a pair of second opposing sidewalls forming a second open chamber;
a pair of sec inward flanges on the pair of second opposing sidewalls that project inwardly toward each other to define a second slit therebetween that extends in a longitudinal direction and opens laterally allowing insertion of the second side of the window shade within the second side channel; and
a plurality of bead structures attached along an edge of the first side and the second side of the shade, wherein each of the plurality of the bead structures is sized at a thickness that is greater than the width of the slit so as to be retained within the first and second side channels while permitting sliding movement of the window shade along the length of each of the two side channels.

2. The system of claim 1, wherein each of the plurality of bead structures is a removable bead structure comprised of a male part having a post and a female part is a hollow ring-like structure that has a plurality of internal flaps to secure placement with respect to the post of the male part.

3. The system of claim 2, wherein each of the bead structures is composed of a flexible or semi-rigid material to facilitate insertion and removal from the two side channels.

4. The system of claim 1 wherein each of the bead structures are attached to an extension strip that is used to adjust the width of the window shade to fit the window frame.

5. The system of claim 1, wherein each of side channels are a side channel assembly, each mounted to a face of the widow frame, each having a cover removably attachable to the first and second side channel.

6. The system of claim 1, wherein each of the first and second side channels are mounted to an interior surface of the widow frame.

7. An operational method for window shade, the operational method comprising:
mounting a first and second side channel, each having an open side with a slit, to a window frame using a connecting means;
attaching a plurality of bead structures to an edge of a first side and a second side of the window shade, wherein each of the plurality of the bead structures is sized at a thickness that is greater than the width of the slit so as to be retained within the first and second side channels while permitting sliding movement of the window shade along the length of each of the two side channels; and
inserting the window shade with the plurality of bead structure into each of the two side channels, wherein the two side channels retain the edges of the first side and the second side of the window shade when the shade is deployed and retracted between an open position and a closed position.

8. The operational method as claimed in claim 7, wherein the assembly of each of the plurality of bead structure is attached an extension strip to the window shade.

9. The operational method as claimed in claim 8, wherein the plurality of bead structures is equidistantly attached along the edges of the first side and the second side of the window shade to provide a uniform spacing when the shade is retracted to the closed position.

10. The operational method as claimed in claim 9, wherein the two side channels include a pair of inward flanges to prevent displacement of the window shade with the plurality of bead structure inserted within the two side channels.
